(19) United States
(12) Patent Application Publication
(10) Pub. No.: US 2026/0002017 A1
(43) Pub. Date: Jan. 1, 2026

(54) EASY MOULD-RELEASING TIRE TREAD RUBBER, PREPARATION METHOD AND TIRE THEREOF

(71) Applicant: GUIZHOU TYRE CO., LTD., Guiyang (CN)

(72) Inventors: Dan WANG, Guiyang (CN); Daiqiang LI, Guiyang (CN); Wang DENG, Guiyang (CN); Tenglong SHE, Guiyang (CN)

(73) Assignee: GUIZHOU TYRE CO., LTD., Guiyang (CN)

(21) Appl. No.: 18/819,965

(22) Filed: Aug. 29, 2024

(30) Foreign Application Priority Data
Jun. 26, 2024 (CN) 202410839691.8

(51) Int. Cl. C08L 7/00; B60C 1/00; B60C 11/00; C08K 3/04; C08K 3/22; C08K 3/34; C08K 5/098; C08K 5/103; C08K 5/20; C08K 5/548; C08K 13/02

(52) U.S. Cl. CPC C08L 7/00; B60C 1/0016; B60C 11/0008; C08K 13/02; B60C 2011/0016; C08K 3/04; C08K 2003/2296; C08K 2003/343; C08K 5/098; C08K 5/103; C08K 5/20; C08K 5/548; C08K 2201/014; C08L 2312/00

(57) ABSTRACT

The present disclosure provides an easy mould-releasing tire tread rubber, a preparation method and a tire thereof. The easy mould-releasing tire tread rubber of the present disclosure, can realize a tire tread with a high percentage of white carbon black by adding an internal releasing agent to the formula. After vulcanization, the tread of the tire forms an isolation film with the surface of the metal mold, which does not react and allows for mould-releasing smoothly, thereby ensuring smooth production and the appearance quality of the finished tire.

### CROSS-REFERENCE TO RELATED APPLICATIONS

The application claims priority to Chinese patent application No. 202410839691.8, filed on Jun. 26, 2024, the entire contents of which are incorporated herein by reference.

### TECHNICAL FIELD

The present disclosure relates to the technical field of tires, in particular to an easy mould-releasing tire tread rubber, a preparation method and a tire thereof.

### BACKGROUND

Due to green development of tire industry, low heat generation of tires is required to reduce the use of petroleum-based materials, and the use of white carbon black as a substitute for carbon black is increasing. However, when tires are vulcanized, the part in contact with the metal mold are easy to react with the surface of the metal mold due to the high content of white carbon black, causing the combination between the mold and rubber, which are not easy to demold after vulcanization, resulting in lacking rubber or tire deformation, which is not conducive to the smoothness of production and the appearance quality of the tires.

Therefore, it is necessary to provide an easy mould-releasing tire tread rubber.

### SUMMARY

In view of this, the present disclosure provides an easy mould-releasing tire tread rubber, a preparation method and a tire thereof to solve the technical defects existing in the prior art.

In a first aspect, the present disclosure provides an easy mould-releasing tire tread rubber, comprising following components in parts by weight:

70 to 100 parts of natural rubber or synthetic rubber, 20 to 80 parts of carbon black reinforcing agent, 15 to 125 parts of white carbon black, 1 to 5 parts of tackifying resin, 5 to 10 parts of chemical additives, and 1 to 10 parts of internal releasing agent.

Preferably, the internal releasing agent comprises a mixture of calcium stearate soap, octadecyl stearamide, stearate, and talcum powder.

Preferably, a mass ratio of the calcium stearate soap, the octadecyl stearamide, the stearate and the talcum powder is (1˜3):(1˜3):(1˜3):(1˜3).

Preferably, the chemical additives comprise at least two of anti-aging agent, vulcanized agent, accelerator, silane coupling agent and zinc oxide.

Preferably, the anti-aging agent comprises an anti-aging agent RD™ and/or an anti-aging agent 4020™;

and/or, the accelerator comprises an accelerator D™ and/or an accelerator CZ™;

and/or, the silane coupling agent comprises an Si-75™ and/or an Si-69™;

and/or, the vulcanized agent is an sulfur.

Preferably, the tackifying resin is a phenolic tackifying resin;

and/or, the stearate is pentaerythritol tetraisostearate.

Preferably, the easy mould-releasing tire tread rubber, comprising following components in parts by weight:

100 parts of natural rubber, 30 parts of carbon black reinforcing agent, 35 parts of white carbon black, 2 parts of phenolic tackifying resin, 1.5 parts of anti-aging agent RD™, 2 parts of anti-aging agent 4020™, 2 parts of sulfur, 1.7 parts of accelerator, 3.5 parts of silane coupling agent, 5 parts of zinc oxide, and 1 to 4 parts of internal releasing agent; and

the internal releasing agent comprises the mixture of calcium stearate soap, octadecyl stearamide, stearate, and talcum powder; and

the mass ratio of the calcium stearate soap, the octadecyl stearamide, the stearate and the talcum powder is 1:1:1:1; and

the stearate is pentaerythritol tetraisostearate.

In a second aspect, the present disclosure also provides a method for preparing the easy mould-releasing tire tread rubber, comprises following steps:

mixing the natural rubber or the synthetic rubber in an mixer to produce a plastic; and

mixing the plastic, the zinc oxide, the white carbon black, the silane coupling agent, the carbon black reinforcing agent, the anti-aging agent, the phenolic tackifying resin, and the internal releasing agent in the mixer; then pressing a bolt, discharging an obtained material to an mixing roll for refining and cooling, adding the vulcanized agent and the accelerator, and milling, cooling to obtain the easy mould-releasing tire tread rubber.

Preferably, placing the natural rubber or the synthetic rubber in the mixer, setting a rotation speed of the mixer to 30 to 55 rpm, pressing the bolt for 55 to 60 s, lifting the bolt and holding for 20 to 25 s, then pressing the bolt and melting for 160 to 165° C. before discharging to produce the plastic; and

placing the plastic, the zinc oxide, the white carbon black, the silane coupling agent, the carbon black reinforcing agent, the anti-aging agent, the phenolic tackifying resin, and the internal releasing agent in the mixer; setting the rotation speed of the mixer to 30 to 55 rpm, pressing the bolt for 25 to 30 s, lifting the bolt and holding for 3 to 5 s, then pressing the bolt and melting for 130 to 135° C. and lifting the bolt and holding for 15 to 20 s; then pressing the bolt to 150 to 155° C. and discharging the obtained material to the mixing roll for refining and cooling to 90 to 100° C., adding the vulcanized agent and the accelerator, and milling for 200 to 300 s; discharging tablets and cooling to obtain the easy mould-releasing tire tread rubber.

In a third aspect, the present disclosure also provides a tire, prepared by using the easy mould-releasing tire tread rubber or the easy mould-releasing tire tread rubber prepared by the method.

The easy mould-releasing tire tread rubber of the present disclosure has following beneficial effects compared to the prior art:

The easy mould-releasing tire tread rubber of the present disclosure, can realize a tire tread with a high percentage of white carbon black by adding an internal releasing agent to the formula. After vulcanization, the tread forms an isolation film with the surface of the metal mold, which does not react and allows for mould-releasing smoothly, thereby ensuring smooth production and the appearance quality of the finished tire.

### DETAILED DESCRIPTION OF THE EMBODIMENTS

The technical solutions in the embodiments of the present disclosure will be described clearly and completely in conjunction with the embodiments of the present disclosure. Apparently, the described embodiments are merely some embodiments, rather than all embodiments, of the present disclosure. Based on the embodiments of the present disclosure, all other embodiments derived by a person of ordinary skill in the art without creative efforts shall fall within the protection scope of the present disclosure.

The easy mould-releasing tire tread rubber of the present disclosure, comprising following components in parts by weight:

70 to 100 parts of natural rubber or synthetic rubber, 20 to 80 parts of carbon black reinforcing agent, 15 to 125 parts of white carbon black, 1 to 5 parts of tackifying resin, 5 to 10 parts of chemical additives, and 1 to 10 parts of internal releasing agent.

The tire tread rubber of the present disclosure, by adding an internal releasing agent to the tire formula, forms an isolation film between the rubber and the metal mould during the vulcanization process after mixing with other materials of the formula, prevents the reaction between the white carbon black in the rubber and the surface of the metal mould, and solves the problem of poor releasing of the tread of the high fraction of white carbon black.

The applicant found that using the tire tread rubber, because of adding internal releasing agent to the formula, can achieve a high percentage of white carbon black tire tread. After completion of vulcanization, an isolation film between the tread of the tire and the surface of the metal mold is formed, no reaction is occurred, and moulding-releasing smoothly, thus ensuring the smooth production and the appearance quality of the finished tire.

In some embodiments, the internal releasing agent comprises a mixture of calcium stearate soap, octadecyl stearamide, stearate, and talcum powder.

Specifically, the calcium stearate soap, also known as calcium stearate, has a molecular formula of Ca[CH₃(CH₂)₁₆COO]₂. The specific stearate is pentaerythritol tetraisostearate.

In some embodiments, a mass ratio of the calcium stearate soap, the octadecyl stearamide, the stearate and the talcum powder is (1˜3):(1˜3):(1˜3):(1˜3).

In some embodiments, the chemical additives comprise at least two of anti-aging agent, vulcanized agent, accelerator, silane coupling agent and zinc oxide.

In some embodiments, the anti-aging agent comprises an anti-aging agent RD™ and/or an anti-aging agent 4020™. Specifically, the anti-aging agent RD™, also known as an antioxidant RD™, or an anti-aging agent 224™, a molecular formula is C₁₂H₁₇N; the anti-aging agent 4020™, also known as an anti-aging agent DMPPD™, a molecular formula is C₁₈H₂₄N₂.

In some embodiments, the accelerator comprises an accelerator D™ and/or an accelerator CZ™; the accelerator D™, also known as diphenylguanidine, has a molecular formula of C₁₃H₁₃N₃; the accelerator CZ™, chemical name is N-cyclohexyl-2-benzothiazoly sulfenamide, a molecular formula is C₁₃H₁₆N₂S₂.

In some embodiments, the silane coupling agent comprises an Si-75™ and/or an Si-69™. Specifically, the Si-75™, also known as bis-(γ-triethoxysilylpropyl)-disulfide; the silane coupling agent Si-69™, chemically known as bis-(γ-triethoxysilylpropyl)-tetrasulfide.

In some embodiments, the vulcanized agent is an sulfur.

In some embodiments, the tackifying resin is a phenolic tackifying resin.

Specifically, the phenolic tackifying resin can be SP-1068™ of Saint Group phenolic anti-slip tackifying resin of the United States, or SL-1401™, tert-butyl phenol-formaldehyde super tackifying resin producted by Huaqi (China) Chemical Co., LTD.

In some embodiments, The carbon black reinforcing agent can be a black cat carbon black reinforcing agent, with models of N234™ and N220™.

In some embodiments, the easy mould-releasing tire tread rubber, comprising following components in parts by weight:

100 parts of natural rubber, 30 parts of carbon black reinforcing agent, 35 parts of white carbon black, 2 parts of phenolic tackifying resin, 1.5 parts of anti-aging agent RD™, 2 parts of anti-aging agent 4020™, 2 parts of sulfur, 1.7 parts of accelerator, 3.5 parts of silane coupling agent, 5 parts of zinc oxide, and 1 to 4 parts of internal releasing agent; and

the internal releasing agent comprises the mixture of calcium stearate soap, octadecyl stearamide, stearate, and talcum powder; and

the mass ratio of the calcium stearate soap, the octadecyl stearamide, the stearate and the talcum powder is 1:1:1:1; and

the stearate is pentaerythritol tetraisostearate.

Based on the same invention idea, the present disclosure also provides a method for preparing the easy mould-releasing tire tread rubber, comprises following steps:

S1, mixing the natural rubber or the synthetic rubber in an mixer to produce a plastic; and

S2, mixing the plastic, the zinc oxide, the white carbon black, the silane coupling agent, the carbon black reinforcing agent, the anti-aging agent, the phenolic tackifying resin, and the internal releasing agent in the mixer; then pressing a bolt, discharging an obtained material to an mixing roll for refining and cooling, adding the vulcanized agent and the accelerator, and milling, cooling to obtain the easy mould-releasing tire tread rubber.

In some embodiments, placing the natural rubber or the synthetic rubber in the mixer, setting a rotation speed of the mixer to 30 to 55 rpm, pressing the bolt for 55 to 60 s, lifting the bolt and holding for 20 to 25 s, then pressing the bolt and melting for 160 to 165° C. before discharging to produce the plastic; and

placing the plastic, the zinc oxide, the white carbon black, the silane coupling agent, the carbon black reinforcing agent, the anti-aging agent, the phenolic tackifying resin, and the internal releasing agent in the mixer; setting the rotation speed of the mixer to 30 to 55 rpm, pressing the bolt for 25 to 30 s, lifting the bolt and holding for 3 to 5 s, then pressing the bolt and melting for 130 to 135° C. and lifting the bolt and holding for 15 to 20 s; then pressing the bolt and melting for 150 to 155° C. and discharging the obtained material to the mixing roll for refining and cooling to 90 to 100° C., adding the vulcanized agent and the accelerator, and milling for 200 to 300 s; discharging tablets and cooling to obtain the easy mould-releasing tire tread rubber.

In some embodiments, using external pressure to extrude the tire tread rubber, and after molding, produce an uncured tire embryo, putting the tire embryo into a vulcanization oven for joint vulcanization to produce finished tires.

Based on the same invention idea, the present disclosure also provides an tire, prepared by the easy mould-releasing tire tread rubber.

The following further illustrates the easy mould-releasing tire tread rubber and its preparation method in this application with specific embodiments. This part further illustrates the content of the present disclosure in combination with specific embodiments, but shall not be construed as a limitation of the present disclosure. If not specifically specified, the technical means employed in the embodiment are conventional means well known to those skilled in the art. Unless otherwise specified, the reagents, methods and equipment used in the present disclosure are conventional reagents, methods and equipment in the field.

In following embodiments, the phenolic tackifying resin is the SP-1068™ of Saint Group phenolic anti-slip tackifying resin of the United States, and the carbon black reinforcing agent is the black cat carbon black reinforcing agent with model number of N234™.

### EXAMPLE 1

An embodiment provides an easy mould-releasing tire tread rubber, comprising following components in parts by weight:

100 parts of natural rubber (the natural rubber is 20 #standard natural rubber NR20™), 30 parts of carbon black reinforcing agent, 35 parts of white carbon black, 2 parts of phenolic tackifying resin, 1.5 parts of anti-aging agent RD™, 2 parts of anti-aging agent 4020™, 2 parts of sulfur, 1.7 parts of accelerator, 3.5 parts of silane coupling agent, 5 parts of zinc oxide, and 2 parts of internal releasing agent; and

the accelerator comprises is an accelerator D™, and

the silane coupling agent is an Si-69™; and

the internal releasing agent comprises the mixture of calcium stearate soap, octadecyl stearamide, stearate (the stearate is specifically pentaerythritol tetraisostearate), and talcum powder; and the mass ratio of the calcium stearate soap, the octadecyl stearamide, the stearate and the talcum powder is 1:1:1:1.

A method for preparing the easy mould-releasing tire tread rubber, comprises following steps:

S1, mixing the natural rubber in an mixer, setting a rotation speed of the mixer to 30 rpm, pressing a bolt for 60 s, lifting the bolt and holding for 20 s, then pressing the bolt and melting for 160° C. before discharging to produce a plastic; and

S2, mixing the plastic, the zinc oxide, the white carbon black, the silane coupling agent, the carbon black reinforcing agent, the anti-aging agent (the anti-aging agent is composed of the anti-aging agent RD™ and the anti-aging agent 4020™), the phenolic tackifying resin, and the internal releasing agent in the mixer; setting the rotation speed of the mixer to 50 rpm, pressing the bolt for 28 s, lifting the bolt and holding for 4 s, then pressing the bolt and melting for 132° C. and lifting the bolt and holding for 18 s; then pressing the bolt and melting for 152° C. and discharging the obtained material to the mixing roll for refining and cooling to 95° C., adding the sulfur and the accelerator, and milling for 250 s; discharging tablets and cooling to obtain the easy mould-releasing tire tread rubber.

### EXAMPLE 2

An embodiment provides an easy mould-releasing tire tread rubber, which is the same as Example 1, except a weight of the internal releasing agent is 1 part, and the rest of the formula is the same as Example 1; and

A preparation method of the easy mould-releasing tire tread rubber in Example 2 is the same as in Example 1.

### EXAMPLE 3

An embodiment provides an easy mould-releasing tire tread rubber, which is the same as Example 1, except a weight of the internal releasing agent is 3 parts, and the rest of the formula is the same as Example 1; and

A preparation method of the easy mould-releasing tire tread rubber in Example 3 is the same as in Example 1.

### EXAMPLE 4

An embodiment provides an easy mould-releasing tire tread rubber, which is the same as Example 1, except a weight of the internal releasing agent is 4 parts, and the rest of the formula is the same as Example 1; and

A preparation method of the easy mould-releasing tire tread rubber in Example 4 is the same as in Example 1.

### Comparative Example 1

An comparative embodiment provides an easy mould-releasing tire tread rubber, which is the same as Example 1, except a weight of the internal releasing agent is 0 part, and the rest of the formula is the same as Example 1; and

A preparation method of the easy mould-releasing tire tread rubber in Comparative Example 1 is the same as in Example 1.

### Performance Testing

The test performance of the tire tread rubber in Examples 1-4 and Comparative Example 1 is shown in Table 1 below.

TABLE 1
The performance of the tire tread rubber in Examples 1-4 and Comparative Example 1

| | test | Comparative | Example | Example | Example | Example |
|---|---|---|---|---|---|---|
| | method | Example 1 | 2 | 1 | 3 | 4 |
| Probability of | count | 73.4% | 52.3% | 7.9% | 7.1% | 3.4% |
| sticking mold | | | | | | |
| Mooney viscosity | GB/ | 67 | 64 | 59 | 55 | 55 |
| ML (1 + 4) | T1232.1 | | | | | |
| 100° C. | | | | | | |
| Bottom | GB/ | 10 | 10 | 11 | 11 | 11 |
| temperature | T 1687.3 | | | | | |
| rise(° C.) | | | | | | |
| Central | GB/ | 98 | 100 | 100 | 101 | 102 |
| temperature | T 1687.3 | | | | | |
| rise(° C.) | | | | | | |
| Wear volume | GB/ | 0.1891 | 0.1813 | 0.1860 | 0.1933 | 0.1960 |
| (cm³) | T 1689 | | | | | |
| Minimum torque | GB/ | 2.35 | 2.23 | 2.09 | 2.01 | 1.92 |
| (ML) (dNm) | T 16584 | | | | | |
| maximum torque | GB/ | 20.52 | 20.31 | 20.03 | 19.21 | 19.55 |
| (MH) (dNm) | T 16584 | | | | | |
| Tc90 (min:s) | GB/ | 11:58 | 11:56 | 12:4 | 12:30 | 12:33 |
| | T 16584 | | | | | |
| rebound | GB/ | 61.2 | 63.4 | 63.8 | 68.4 | 68.2 |
| resilience (%) | T 1681 | | | | | |
| Tear | GB/ | 61.0 | 69.2 | 73.2 | 57.2 | 57.8 |
| strength(kN/m) | T 529 | | | | | |
| Shore hardness | GB/ | 62 | 62 | 61 | 60 | 60 |
| (A) | T 531.1 | | | | | |
| Stress at 100% | GB/ | 3.5 | 3.4 | 3.4 | 3.1 | 3.3 |
| definite | T 528 | | | | | |
| elongation (MPa) | | | | | | |
| Stress at 300% | GB/ | 16.7 | 16.7 | 16.6 | 15.1 | 15.6 |
| definite | T 528 | | | | | |
| elongation(MPa) | | | | | | |
| tensile strength | GB/ | 26.5 | 25.8 | 26.8 | 25.0 | 25.3 |
| (MPa) | T 528 | | | | | |
| elongation at | GB/ | 457 | 463 | 489 | 493 | 498 |
| break (%) | T 528 | | | | | |

From Table 1, it can be seen that as the parts by weight of internal releasing agent increases, the probability of sticking to the mold gradually decreases. However, the main components of the internal releasing agent are the mixture of calcium stearate soap, octadecyl stearamide, stearate, and talcum powder, the increase in parts by weigh used has a negative impact on the performance of the tire tread. It is recommended to add 2 parts by weight of internal releasing agent. For various performance verifications, studies have shown that using 2 parts by weight of internal releasing agent has almost no negative effect on the physical properties of the tread rubber, but the probability of the tread sticking to the mold is greatly reduced.

The foregoing descriptions are merely preferred embodiments of the present disclosure, and are not intended to limit the present disclosure. Within the spirit and principles of the present disclosure, any modifications, equivalent substitutions, improvements, etc., are within the protection scope of the present disclosure.

What is claimed is:

1. An easy mould-releasing tire tread rubber, wherein comprising following components in parts by weight:
70 to 100 parts of natural rubber or synthetic rubber, 20 to 80 parts of carbon black reinforcing agent, 15 to 125 parts of white carbon black, 1 to 5 parts of tackifying resin, 5 to 10 parts of chemical additives, and 1 to 10 parts of internal releasing agent.

2. The easy mould-releasing tire tread rubber according to claim 1, wherein the internal releasing agent comprises a mixture of calcium stearate soap, octadecyl stearamide, stearate, and talcum powder.

3. The easy mould-releasing tire tread rubber according to claim 2, wherein a mass ratio of the calcium stearate soap, the octadecyl stearamide, the stearate and the talcum powder is (1˜3):(1˜3):(1˜3):(1˜3).

4. The easy mould-releasing tire tread rubber according to claim 1, wherein the chemical additives comprise at least two of anti-aging agent, vulcanized agent, accelerator, silane coupling agent and zinc oxide.

5. The easy mould-releasing tire tread rubber according to claim 4, wherein the anti-aging agent comprises an anti-aging agent RD™ and/or an anti-aging agent 4020™;
and/or, the accelerator comprises an accelerator D™ and/or an accelerator CZ™;
and/or, the silane coupling agent comprises an Si-75™ and/or an Si-69™.
and/or, the vulcanized agent is an sulfur.

6. The easy mould-releasing tire tread rubber according to claim 2, wherein the tackifying resin is a phenolic tackifying resin; and/or, the stearate is pentaerythritol tetraisostearate.

7. The easy mould-releasing tire tread rubber according to claim 4, wherein comprising following components in parts by weight:
100 parts of natural rubber, 30 parts of carbon black reinforcing agent, 35 parts of white carbon black, 2 parts of phenolic tackifying resin, 1.5 parts of anti-aging agent RD™, 2 parts of anti-aging agent 4020™, 2 parts of sulfur, 1.7 parts of accelerator, 3.5 parts of silane coupling agent, 5 parts of zinc oxide, and 1 to 4 parts of internal releasing agent, and
the internal releasing agent comprises the mixture of calcium stearate soap, octadecyl stearamide, stearate, and talcum powder, and
the mass ratio of the calcium stearate soap, the octadecyl stearamide, the stearate and the talcum powder is 1:1:1:1; and
the stearate is pentaerythritol tetraisostearate.
